(19) United States
(12) Patent Application Publication
(10) Pub. No.: US 2017/0313235 A1
(43) Pub. Date: Nov. 2, 2017

(54) AUTOMOBILE HEADLAMP OUTER LENS WITH OVERMOLDED METAL ELECTRODES

(71) Applicant: VALEO VISION, Bobigny cedex (FR)

(72) Inventors: Erwan FAOUCHER, Angers (FR); Michel Juton, Angers (FR); Francois Gratecap, Angers (FR)

(73) Assignee: VALEO VISION, Bobigny cedex (FR)

(21) Appl. No.: 15/581,965

(22) Filed: Apr. 28, 2017

(30) Foreign Application Priority Data
Apr. 29, 2016 (FR) 16 53881

(51) Int. Cl. B60Q 1/00; F21S 8/10

(52) U.S. Cl. CPC B60Q 1/0005; F21S 48/1233; F21S 48/34

(57) ABSTRACT

The invention relates to an outer lens for a luminous device, in particular for a motor vehicle. The outer lens include a main portion made of transparent plastic, at least two edges for fastening to a housing of the luminous device, an electrically conductive coating forming a defrosting and/or demisting electrical resistor, and at least two electrodes that are electrically connected to the conductive coating. The electrodes are located on the fastening edges and are overmolded by the transparent plastic. The invention also relates to a luminous device including the outer lens in question and a process for producing the outer lens.

The invention relates to the field of lighting and luminous signaling, in particular for motor vehicles. More precisely, the invention relates to the field of luminous devices, in particular for motor vehicles, comprising a housing and an outer lens closing said housing.

Published patent document US 2014/033 2518 A1 discloses a motor-vehicle headlamp outer lens comprising on its interior face an electrically conductive coating intended to serve as an electrical resistor for defrosting the outer lens. To do this, the coating forms one or more tracks deposited on the outer lens. Electrodes are placed at two opposite ends of the zone of the metal tracks, so as to allow the current supplied to defrost the outer lens to be uniformly distributed to the various tracks. The electrodes are fastened and connected to the metal tracks by soldering or by a conductive adhesive. Each of these electrodes is a distance away from the edges of the outer lens and is intended to be connected to an electrical power supply. This teaching however does not specify in what way this connection is achieved.

Published patent document DE 20 2012 005 908 U also discloses a motor-vehicle headlamp outer lens. The outer lens comprises, on its exterior face this time, an electrically conductive coating, with a view to forming an electrical resistor for defrosting said outer lens. The coating forms an apparently continuous layer that contains carbon nanotubes. A protective varnish is deposited on the electrically conductive coating with a view to protecting it. The way in which the electrically conductive coating is connected is not detailed in this teaching. In addition, this teaching is specifically limited to an electrically conductive coating placed on the exterior face of the outer lens, with a view to defrosting said outer lens in winter.

Published patent document US 2007/018 1565 A1 discloses, similarly to the aforementioned documents, a motor-vehicle headlamp outer lens comprising an electrically conductive coating, with a view to forming an electrical resistor for defrosting said outer lens. The coating comprises an electrically conductive track forming zigzags. The tracks terminate in a connector placed on the interior face of a rim portion of the outer lens. A plug may then be connected to the connector with a view to supplying electrical power to the defrosting resistor. This teaching is interesting in that it discloses the measures necessary for the electrical connection of the defrosting resistor. These measures are however limited to an electrical resistor taking the form of a zigzagging track that terminates in two terminals to which power is supplied. It is generally possible to see these tracks. In addition, the connector requires the outer lens to have a rim portion and the electrical connection is necessarily made in the interior of the housing.

The objective of the invention is to provide a solution that mitigates at least one drawback of the prior art, and more particularly the aforementioned prior art. Even more precisely, the objective of the invention is to provide a way of defrosting and/or demisting an outer lens for a luminous device that is effective, economical and practical.

One subject of the invention is an outer lens for a luminous device, in particular for a motor vehicle, said outer lens comprising: a main portion made of transparent plastic; at least two edges for fastening to a housing of the luminous device; an electrically conductive coating forming a defrosting and/or demisting electrical resistor; at least two electrodes that are electrically connected to the conductive coating; noteworthy in that the electrodes are located on the fastening edges and are overmolded by the transparent plastic.

According to one advantageous refinement of the invention, at least one and preferably each of the electrodes comprises a portion located at an exterior end of the edge so as to be able to be supplied with electrical power via the exterior of the housing.

According to one advantageous refinement of the invention, each of the electrodes comprises a connector that is intended to allow the supply of electrical power.

According to one advantageous refinement of the invention, each of the connectors comprises at least one electrical pin that protrudes from the electrode comprising said connector, and a device for engaging with a plug, said device being an electrical insulator and said one or more pins being electrically connected to said electrode.

According to one advantageous refinement of the invention, each of the engaging devices forms a ring encircling the one or more corresponding pins, said ring comprising means for mechanically engaging with the plug.

According to one advantageous refinement of the invention, the electrodes are made of metal and preferably of bronze, copper or galvanized steel.

According to one advantageous refinement of the invention, each of the engaging devices is overmolded onto the corresponding electrode, preferably via a platform.

According to one advantageous refinement of the invention, each of the edges comprise an electrode having a cross section forming a dog-legged profile, each of the electrodes extending along one of said edges following said dog-legged profile.

According to one advantageous refinement of the invention, the electrically conductive coating covers the electrodes, preferably on an interior face of said outer lens.

According to a first embodiment of the invention, the electrically conductive coating is a varnish containing metal oxides, preferably tin and indium oxides. The metal oxides may be a single or a combination of the following oxides: aluminum-doped zinc oxide AZO; indium-tin oxide ITO; zirconium oxide ZrO₂; tantalum oxide Ta₂O₅; antimony-doped tin oxide ATO.

Advantageously, the electrically conductive coating comprises a binder. The binder may be a neutral binder based on acrylic, polyester and/or polymers. The binder may also be a conductive binder based on conductive polymers, preferably based on polyacrylonitrile, polyphenylene sulfide (PPS) and/or PEDOT: PSS.

According to a second embodiment, the electrically conductive coating is based on an electrically conductive organic material. Advantageously, the organic material is composed of transparent electrically conductive polymers. Preferably, the polymers are polyphenylene sulfide (PPS) or PEDOT:PSS.

Advantageously, the electrically conductive coating takes the form of a film that extends continuously preferably over more than 50% of the surface of the main portion of the outer lens.

According to one advantageous refinement of the invention, each of the electrodes extends over at least 50% of the length of the edge comprising it.

According to one advantageous refinement of the invention, each of the electrodes comprises a body extending in a main direction and branches extending transversely to the body toward the electrically conductive coating.

Another subject of the invention is a luminous device, in particular for a motor vehicle, said device comprising: a housing forming an open cavity; an outer lens fastened to the housing and closing the cavity; at least one luminous module in the cavity; noteworthy in that the outer lens is according to the invention.

Another subject of the invention is a process for producing an outer lens for a luminous device, in particular for a motor vehicle, said process being noteworthy in that the outer lens is according to the invention and by the following steps: (a) a step in which the electrodes are placed in a mold; (b) a step in which the transparent plastic is injected into the mold onto the electrodes.

According to one advantageous refinement of the invention, the mold comprises means for holding the electrodes in place in step (a).

The measures of the invention are advantageous in that they allow the defrosting and/or demisting function of the outer lens for a luminous device to be supplied with electrical power effectively and economically. Specifically, the fact of placing the electrodes on the fastening edges has a first advantage of placing them in zones that cannot be seen from the exterior. This also has a second advantage of allowing an electrical connection to be made from the exterior of the device. The connection plugs and connectors may thus be placed outside of the zone visible from the exterior.

Other features and advantages of the present invention will be better understood from the description and drawings, in which:

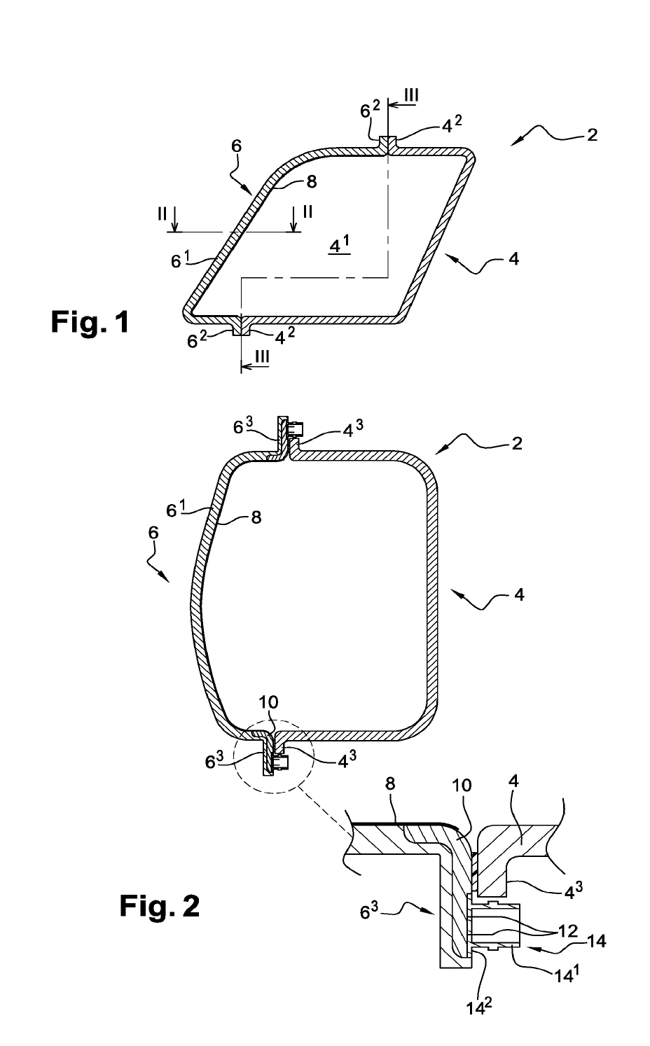

FIG. 1 is a sectional view of a longitudinal and vertical sectional plane through a luminous-device housing with an outer lens according to the invention;

FIG. 2 is a sectional view of the housing in FIG. 1, the section being indicated by the line II-II;

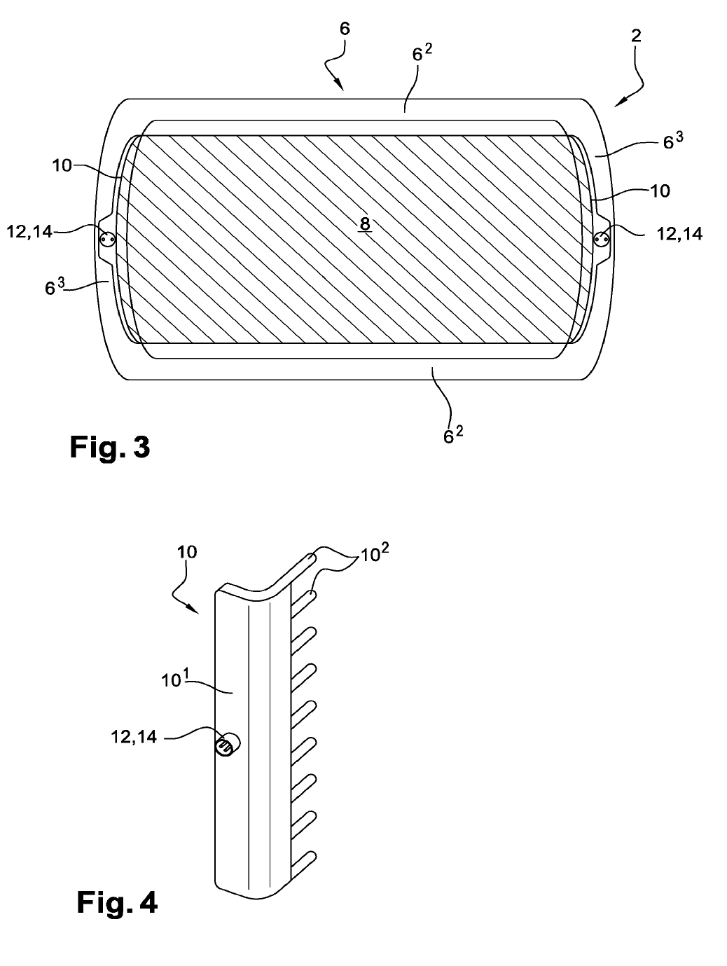

FIG. 3 is a sectional view of the housing in FIG. 1, the section being indicated by the line II-II;

FIG. 4 is a perspective view of an alternative configuration of the electrodes.

FIGS. 1 to 3 illustrate an exemplary embodiment of a luminous device according to the invention. FIG. 1 is a vertical longitudinal sectional view showing the device, the device being in the position it normally is when mounted in a vehicle. FIGS. 2 and 3 are sectional views, the sections being indicated by the lines II-II and III-III.

With reference to FIG. 1, the luminous device 2 comprises a housing 4 forming a cavity 4¹ with an aperture, said aperture being covered by the outer lens 6. The housing 4 is advantageously made of plastic. It may consist of a plurality of elements that are fastened to one another. The outer lens is transparent and advantageously made from a plastic such as in particular polycarbonate (PC). The outer lens 6 comprises a main portion 6¹ through which the light rays of one or more luminous modules placed in the cavity of the housing 4 are intended to pass. It also comprises upper and lower edges 6² that are intended to interact with corresponding edges 4² of the housing 4.

The main portion 6¹ of the outer lens 6 advantageously comprises, on its interior face, an electrically conductive coating 8 that is able to form an electrical resistor for defrosting and/or demisting the outer lens 6. This coating is advantageously a continuous coating taking the form of a varnish that may comprise an electrically conductive filler, such as a filler composed of indium-tin oxides for example. The indium-tin oxide (or tin-doped indium oxide or ITO) is a mixture of indium (III) oxide (In₂O₃) and tin (IV) oxide (SnO₂), in a proportion by weight typically of 90% of the first and 10% of the second. This compound is colorless and transparent in thin layers. The most important characteristic of indium-tin oxide is its combination of electrical conductivity and optical transparency. Other conductive filler materials may be envisioned. The varnish advantageously comprises a neutral binder, for example one based on acrylic, polyester and/or polymers. The binder may also be a conductive binder based on conductive polymers and preferably based on polyacrylonitrile, polyphenylene sulfide (PPS) or PEDOT:PSS. It may optionally comprise an electrically conductive filler material such as the aforementioned metal oxides. The abbreviation PEDOT:PSS designates a blend of two polymers, poly(3, 4-ethylenedioxythiophene) (PEDOT) and sodium polystyrene sulfonate (PSS).

Alternatively, the electrically conductive coating is based on an electrically conductive organic material. Advantageously, the organic material is composed of transparent electrically conductive polymers. Preferably, the polymers are polyphenylene sulfide (PPS) or PEDOT:PSS.

The resistivity of this coating may be comprised between 1E-5 and 1E-4 Ω.m. The overall resistance of the coating may be comprised between 10 and 100Ω. The overall resistance will also depend on the size of the treated zone. The coating may be deposited with a thickness comprised between 1 and 5 μm and preferably between 2 and 3 μm.

FIG. 2 is a sectional view of the device 2 in FIG. 1, the section being indicated by the line II-II. It may be seen that the outer lens 6 comprises lateral edges 6³ that interact with corresponding edges 4³ of the housing 4. These lateral edges 6³ comprise electrodes 10 embedded in the plastic forming the outer lens 6. It may also be seen that the electrically conductive coating 8 extends transversely to the point that it covers the electrodes 10. Specifically, the latter are positioned level with the edges 6³ so as to freely present their internal faces, the latter then being able to make direct contact with the electrically conductive coating 8.

The electrodes are advantageously made of metal, such as in particular of copper, bronze or galvanized steel.

FIG. 2, and more precisely the zone shown enlarged in a circle, also shows details of the positioning of one of the electrodes 10 with respect to the material of the outer lens, which is overmolded. The electrode 10 has a cross section with a dog-legged profile that matches the dog-legged profile of the edge 6³. This dog-legged profile of the electrode 10 allows an electrical connection to be made between the internal face of the outer lens 6, to which the conductive coating 8 is applied, and the exterior of the luminous device 2, with a view to supplying electrical power thereto. A connector 12+14 is placed on the electrode 10. It comprises one or more electrical pins 12 that protrude from the electrode 10 and that are electrically connected to said electrode 10. It also comprises a device 14 for engaging with a plug (not shown). Said device may be formed by an annular wall 14¹ made of electrical insulator and a platform 14² integrally formed with the annular wall and overmolded onto the electrode 10. The annular wall 14¹ encircles the pins 12. Mechanical engaging means may be provided on the annular wall 14¹, with a view to ensuring the plug (not shown) is retained. What was just described for one edge 6³ of the device 2 also goes for the opposite edge 6³.

In the representation in FIG. 2, the connectors 12+14 are provided on the exterior of the housing 4. It will however be understood that they may be provided in the interior.

FIG. 3 is a sectional view, the section being indicated by the line III-III in FIG. 1, i.e. it is a back view of the outer lens 6. The fact that the conductive coating 8 extends over essentially the entire width of the outer lens, from one of the lateral edges 6³ to the opposite edge 6³, may be seen. It may also be seen that each electrode 10 extends longitudinally along the corresponding edge 6³.

In the representation in FIGS. 2 and 3, the electrodes 10 are placed on the lateral edges 6³, so as to generate a current in an essentially horizontal direction along the conductive coating 8. It will however be understood that the electrodes 10 may, also or alternatively, be placed on the upper and lower edges 6². In this case, the current flowing through the conductive coating 10 will be oriented essentially vertically. Also alternatively, it is envisionable to provide an electrode on an upper or lower edge 6² and another electrode on a lateral edge 6³, the current then essentially being oblique. In other words, various configurations of the electrodes are possible on the edges 6² and 6³, provided that they make it possible to make a current flow along the conductive coating 8.

FIG. 4 is an illustration of an alternative configuration of the electrodes. The electrode 10 that is shown comprises a body 10¹ that extends longitudinally along the edge of the outer lens, in which body the electrode is intended to be housed, and branches 10² that extend transversely and preferably perpendicularly to the longitudinal body 10¹. The conductive coating then advantageously makes contact only with the branches 10², the latter then ensuring, via the body 10¹, the distribution of the current along the edge of the outer lens.

In FIGS. 2 and 4, the electrodes are shown as having a dog-legged cross section. However it will be noted that it is envisionable for the body of the electrodes to not be dog-legged but indeed, for example, generally flat, in particular depending on the configuration of the outer lens and on whether the connector is located in the interior or on the exterior of the housing.

The outer lens that was just described may be produced as follows. The electrodes are placed in a dedicated mold, in their final locations level with the edges of the outer lens to be formed. They may moreover be fastened to the mold by conventional means, such as the production of ad hoc housings and/or magnetized zones ensuring retention thereof. The mold is then closed by a counter-mold and the transparent material of the outer lens is then injected in liquid or paste form into the mold, thus covering the electrodes. The latter are thus overmolded. Once the injected material has cooled, it is possible to open the mold and take out the outer lens thus formed. The electrically conductive coating may then be applied to the outer lens so as to make contact with the electrodes. The electrodes may undergo a conventional surface treatment well known to those skilled in the art in order to ensure good cohesion with the transparent material.

1. Outer lens for a luminous device, in particular for a motor vehicle, said outer lens comprising:
a main portion made of transparent plastic;
at least two edges for fastening to a housing of the luminous device;
an electrically conductive coating forming a defrosting and/or demisting electrical resistor;
at least two electrodes that are electrically connected to the conductive coating;
wherein the electrodes are located on the fastening edges and are overmolded by the transparent plastic.

2. Outer lens according to claim 1, wherein at least one and preferably each of the electrodes comprises a portion located at an exterior end of the corresponding edge so as to be able to be supplied with electrical power via the exterior of the housing.

3. Outer lens according to claim 2, wherein each of the electrodes comprises a connector that is intended to allow the supply of electrical power.

4. Outer lens according to claim 3, wherein each of the connectors comprises at least one electrical pin that protrudes from the electrode comprising said connector, and a device for engaging with a plug, said device being made of an electrical insulator and said one or more pins being electrically connected to said electrode.

5. Outer lens according to claim 4, wherein each of the engaging devices comprises a ring encircling the one or more corresponding pins, said ring comprising means for mechanically engaging with the plug.

6. Outer lens according to claim 1, wherein the electrodes are made of metal and preferably of bronze, copper or galvanized steel.

7. Outer lens according to claim 5, wherein each of the engaging devices is overmolded onto the corresponding electrode, preferably via a platform.

8. Outer lens according to claim 7, wherein each of the edges comprising the electrodes has a cross section forming a dog-legged profile, each of the electrodes extending along one of said edges following said dog-legged profile.

9. Outer lens according to claim 8, wherein the electrically conductive coating covers the electrodes, preferably on an interior face of said outer lens.

10. Outer lens according to claim 9, wherein the electrically conductive coating is a varnish containing metal oxides, preferably tin and indium oxides.

11. Outer lens according to claim 10, wherein each of the electrodes extends over at least 50% of the length of the edge comprising it.

12. Outer lens according to claim 10, wherein each of the electrodes comprises a body extending in a main direction and branches extending transversely to the body toward the electrically conductive coating.

13. Luminous device, in particular for a motor vehicle, said device comprising:
a housing forming an open cavity;
an outer lens fastened to the housing and closing the cavity;
at least one luminous module in the cavity;
wherein the outer lens is according to claim 1.

14. Process for producing an outer lens for a luminous device, in particular for a motor vehicle, wherein the outer lens process is according to claim 1 and by the following steps:
(a) a step in which the electrodes are placed in a mold;
(b) a step in which the transparent plastic is injected into the mold onto the electrodes.

15. Process according to claim 14, wherein the mold comprises means for holding the electrodes in place in step.

16. Outer lens according to claim 1, wherein each of the electrodes comprises a connector that is intended to allow the supply of electrical power.

17. Outer lens according to claim 5, wherein the electrodes are made of metal and preferably of bronze, copper or galvanized steel.

18. Outer lens according to claim 1, wherein each of the edges comprising the electrodes has a cross section forming a dog-legged profile, each of the electrodes extending along one of said edges following said dog-legged profile.

19. Outer lens according to claim 1, wherein the electrically conductive coating covers the electrodes, preferably on an interior face of said outer lens.

20. Outer lens according to claim 19, wherein the electrically conductive coating is a varnish containing metal oxides, preferably tin and indium oxides.
